(19) United States
(12) Patent Application Publication
(10) Pub. No.: US 2021/0321230 A1
(43) Pub. Date: Oct. 14, 2021

(54) STUDENT-CONTROLLED TEXT MESSAGE REMINDERS WITH THIRD PARTY LEARNING MANAGEMENT SYSTEMS

(71) Applicant: Lazy Texts, LLC., Coral Springs, FL (US)

(72) Inventors: Charles Levine, Coral Springs, FL (US); Harrison Cohn, Parkland, FL (US)

(21) Appl. No.: 17/228,442

(22) Filed: Apr. 12, 2021

Related U.S. Application Data
(60) Provisional application No. 63/008,802, filed on Apr. 12, 2020.

(51) Int. Cl. H04W 4/14; H04L 12/58; G09B 5/12; G09B 5/14

(52) U.S. Cl. CPC H04W 4/14; H04L 51/063; G09B 5/14; G09B 5/125; H04L 51/14

(57) ABSTRACT

A computing device and computer-implemented method to provide student-control short message service (SMS). The method begins with accessing, by a server, data in a third-party format from a third-party server. The server and the third-party server are controlled by different business entities. Next, the data in the third-party format is filtered, which has been accessed according to student preferences, the student preferences including a mobile device identifier. Next, the data in the third-party format is converted which as specified by the student preferences into a format compatible with the SMS protocol or an instant message for receipt by a messaging app. Finally, the data is sent in which has been converted into the SMS format or instant message to the mobile device as specified by the mobile device identifier.

### CROSS-REFERENCE TO RELATED APPLICATIONS

This application claims priority from and is related to U.S. Provisional Application No. 63/008,802, filed Apr. 12, 2020, which is hereby incorporated into the present application by reference in their entirety.

### BACKGROUND

The disclosure relates to a system and method for student-controlled text message reminders of academic assignments.

Learning management systems (LMS), such as, Canvas, Google Classroom, Blackboard, Schoology, Docebo, TalentLMS, Edmodo continue to grow in popularity. For example, Canvas®, is a web-based LMS now used by more than 3,000 universities, school districts, and institutions around the world. LMS systems deliver and manage all types of content, including video, courses, and documents. In the education and higher education markets, an LMS will include a variety of functionality that is similar to corporate but will have features such as rubrics, teacher and instructor facilitated learning, a discussion board, and often the use of a syllabus.

Canvas® is a powerful and flexible platform that includes many features and allows third-party developers to offer additional features. For example, Canvas® offers SMS notifications, including course content. This is how Canvas® notifies students about their upcoming planner items. One limitation with Canvas's system is that students are only notified when a planner item is posted or changed. As a result, students can miss assignments.

### SUMMARY

In one example disclosed is a method for providing student-control short message service (SMS). The method begins with accessing, by a server, data in a third-party format from a third-party server, wherein the server and the third-party server are controlled by different business entities. The third-party server can be running one of any one or more of a learning management system, email system, and other data sources The accessing is performed using one or more of API calls, web scrapping, file transfer protocol (FTP), and http methods.

Next, the data in the third-party format is filtered, which has been accessed according to student preferences, the student preferences including a mobile device identifier. The filtering includes one or more of show courses, skip courses, set days, and skip completed to-dos. Next, the data in the third-party format is converted which as specified by the student preferences into a format compatible with the SMS protocol or an instant message for receipt by a messaging app. The student preferences for formatting include one or more of customized course names, time format, time-zone, name, and limit reminder amount. Finally, the data is sent in which has been converted into the SMS format or instant message to the mobile device as specified by the mobile device identifier. In one example, the data is sent which has been converted into the SMS format to an SMS gateway to send to the mobile device as specified by the mobile device identifier.

In another example the process continues by accessing, by the server, data in an additional third-party format from an additional third-party server, wherein the server and the additional third-party server are controlled by different business entities. Next, the data is filtered in the additional third-party format which has been accessed according to student preferences, the student preferences including a mobile device identifier. Next, the data is converted in the additional third-party format which as specified by the student preferences into a format compatible with the SMS protocol or an instant message for receipt by a messaging app. Finally, the data is sent which has been converted into the SMS format or instant message to the mobile device as specified by the mobile device identifier.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 is an example flowchart of the system and method, according to the present invention;

FIG. 2 is an example screenshot of a webpage where a first-time user can sign up for the service or a returning user can sign-in to their account, according to the present invention;

FIG. 3 and FIG. 4 are screenshots of example webpages where a user can add and/or edit their settings, according to the present invention;

FIG. 5 are a screenshot of an example webpage that a user can preview the text message that would be received based on the settings, according to the present invention;

FIG. 6 is a sample text message a user would receive with upcoming assignments according to the present invention;

FIG. 7 is a diagram depicting the operating environment, according to the present invention;

FIG. 8 is a block diagram illustrating one example of a client or server information processing system, according to the present invention;

FIG. 9 is a diagram of the data handling process, according to the present invention; and

FIG. 10 is a table of student filter and formatting preferences, according to the present invention.

### DETAILED DESCRIPTION

As required, embodiments are disclosed herein; however, it is to be understood that the disclosed embodiments are merely examples and that the methods described below can be embodied in various forms. Therefore, specific structural and functional details disclosed herein are not to be interpreted as limiting, but merely as a representative basis for teaching one skilled in the art to variously employ the present subject matter in virtually any appropriately detailed structure and function. Further, the terms and phrases used herein are not intended to be limiting, but rather, to provide an understandable description of the concepts.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

### Non-Limiting Definitions

The terminology used herein is for the purpose of describing particular embodiments only and is not intended to be limiting of the invention. As used herein, the singular forms “a”, “an” and “the” are intended to include the plural forms as well, unless the context clearly indicates otherwise.

The term “access” refers to gathering information from a third-party application, such as a learning management system or calendaring application. Access is accomplished through API calls, web scrapping, file transfer protocol (FTP), and http methods.

The term “application programming interface” or API is an interface that defines interactions between multiple software applications. It defines the kinds of calls or requests that can be made, how to make them, the data formats that should be used, the conventions to follow, etc. APIs for email systems such as GMAIL and Microsoft Outlook, language learning systems, and other data sources are published by the software provider.

The term “client device” is any device, such as a computer, laptop, smartphone, tablet, television, or other information processing device in which web-browsers and apps can be processed.

The terms “comprises” and/or “comprising,” specify the presence of stated features, steps, operations, elements, and/or components, but do not preclude the presence or addition of one or more other features, integers, steps, operations, elements, components, and/or groups thereof.

The term “message” is a short message service or instant message using a messaging app such a Discord, Facebook Messenger, iMessage, Signal, Slack, Telegram, WhatsApp, WeChat and QQ Messenger, Viber, Line, and Snapchat and other apps that enable instant messaging.

The term “SMS Gateway” is facilitate SMS traffic between businesses and mobile subscribers, including SMS for enterprises, content delivery, and entertainment services involving SMS, e.g. TV voting. Considering SMS messaging performance and cost, as well as the level of messaging services, SMS gateway providers can be classified as aggregators or SS7 providers.

The term “SMS message” or short message service message is a text messaging service component of most telephone, Internet, and mobile device systems. It uses standardized communication protocols that let mobile devices exchange short text messages. The service allows users to send and receive messages of up to 160 characters (when entirely alpha-numeric) to and from GSM mobiles. Although most SMS messages are sent from one mobile phone to another, support for the service has expanded to include other mobile technologies, such as ANSI CDMA networks and Digital AMPS.

The term “student preferences” means a customizable configuration value used to select, filter, format and time when SMS message are sent based on data from a third-party platform. Student preferences include customize course names, time (e.g., message is sent at 5 AM), time-zone, name (e.g., Hey JOHN DOE, here are your upcoming reminders:), show courses (e.g., Biology Assignment: XYZ versus Assignment: XYZ), customize course name (e.g., change BSC1101 to Bio), skip courses (e.g., ALL reminders from BSC1000 will be excluded.), set days (e.g., choose to only see reminders that are 5 days out), limit reminder amount (e.g., choose to only see next 5 reminders), and skip completed to-dos (e.g., if reminder marked complete on the third-party reminder service it will be excluded from text).

The term “third-party platform” means a party that is a separate business entity from the party using student preferences to access data. Third-party systems include email systems such as Gmail and Microsoft Outlook, language learning systems, and other data sources.

The phrase “web scraping” means a process of using bots to extract content and data from a website. Typically web scraping extracts underlying HTML code and, with it, data stored in a database.

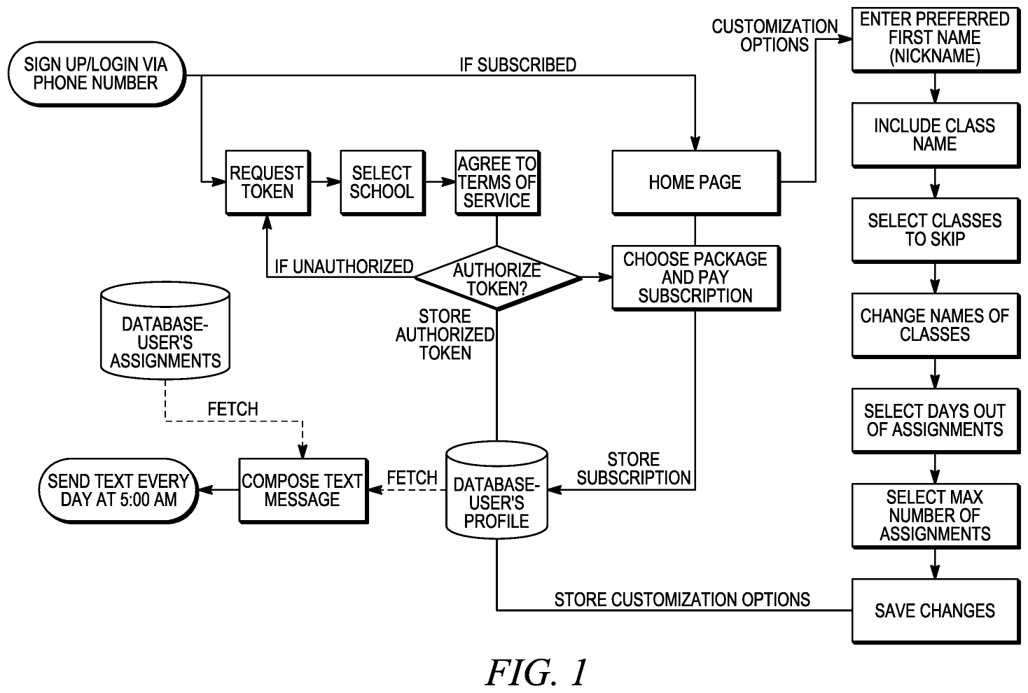

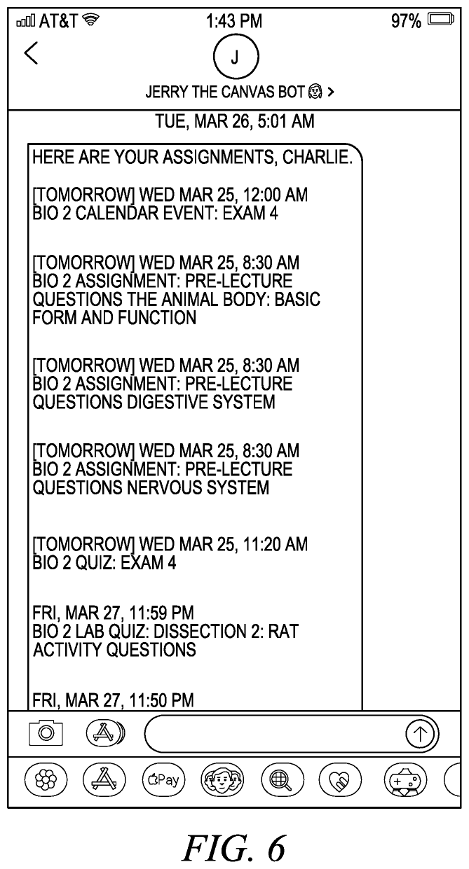

With reference to FIG. 1-6, a main feature of the system and method according to the disclosure (commercial name—Lazy Text™ App) is to text users a list of the upcoming items on their Canvas® planner. The types of planner items that can be found on a planner are assignments, quizzes, discussion topics, announcements, and calendar events. The Lazy Text™ App fetches the items from the user's Canvas® planner that are due within the number of days the user specifies. It then filters the list based on the user's several customizations and compiles one or more text messages to send.

Currently, up to three text messages are part of the Lazy Text™ App, but the disclosure contemplates additional text messages. The first text includes a user's assignments, quizzes, and discussion posts; the second text includes a user's announcements; and the third text includes a user's calendar events. All users receive at least the first text, with the last two texts being optional. Text messages display each planner item by showing its due date, course, type (assignment, quiz, etc.), and name. Users may also opt to receive more than one text per day and select the times at which the texts will be sent. Available customizations options can depend on the subscription package that the user selects.

The user personalizes their text message with customization options on the Lazy Texts website, lazytexts.com, where the user creates an account with their phone number. Their customizations are saved on their account and can be changed at any time to be applied to the next text they receive. The next text they receive can be previewed on the website, and the preview is updated whenever the user saves their changes.

The first customization option is their preferred first name (nickname) that they will be called in the opening sentence of the text. The user then selects if they want the course associated with each planner item to be included in their text. The user can also choose to omit certain courses from a list of courses they are enrolled in. Users also have the option to change the name of each course from that used in Canvas®, where they are encouraged to shorten the name of their courses, to keep the texts more concise and therefore more readable for the user. The course name change can also be reflected in their Canvas®. Finally, users can set a limit to the planner items they receive, by both specifying the maximum number of days out for each planner item to be, and the maximum number of planner items to fully display in the text; the remainder of planner items are displayed as a number at the end of the text.

The user's customization options are stored in a database. They are set to default values when the user signs up on the website. The main program that sends the texts runs independently of the website and is pulling the user's customization options at runtime. The website is intended first for the user to sign up to receive their texts and then as a means for the user to log in easily to modify their customization options.

As previously noted, Canvas does offer SMS notifications, including course content. One problem with Canvas's system is that students are only notified when a planner item is posted or changed. Furthermore, the notifications that Canvas offers for course content are not customizable. What sets the Lazy Text™ App apart is that it is more user-friendly and gives the user a vast array of customization options, as detailed above, to allow them to receive no more and no less than what they need to see to keep them organized.

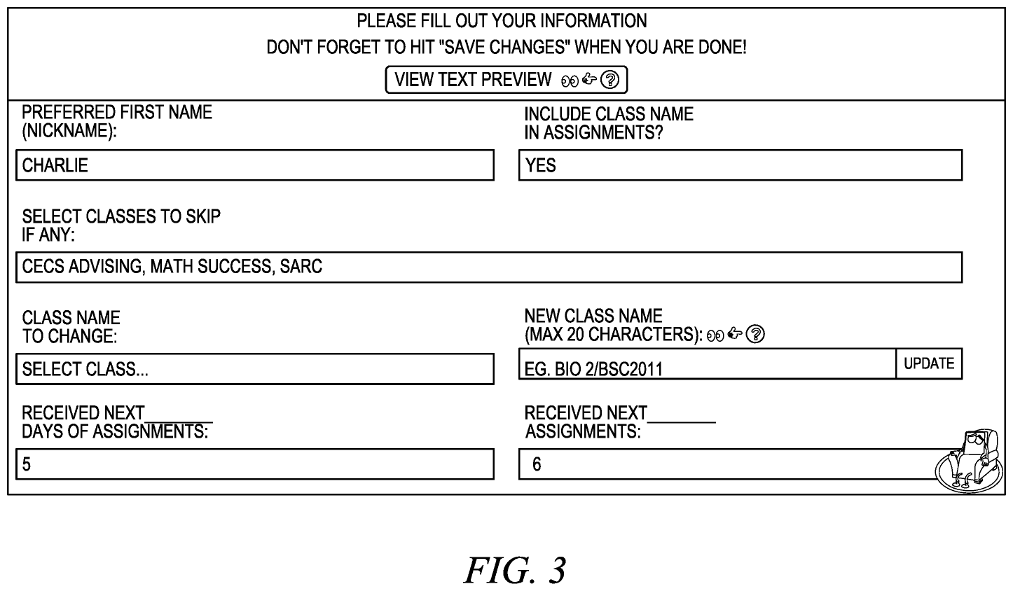

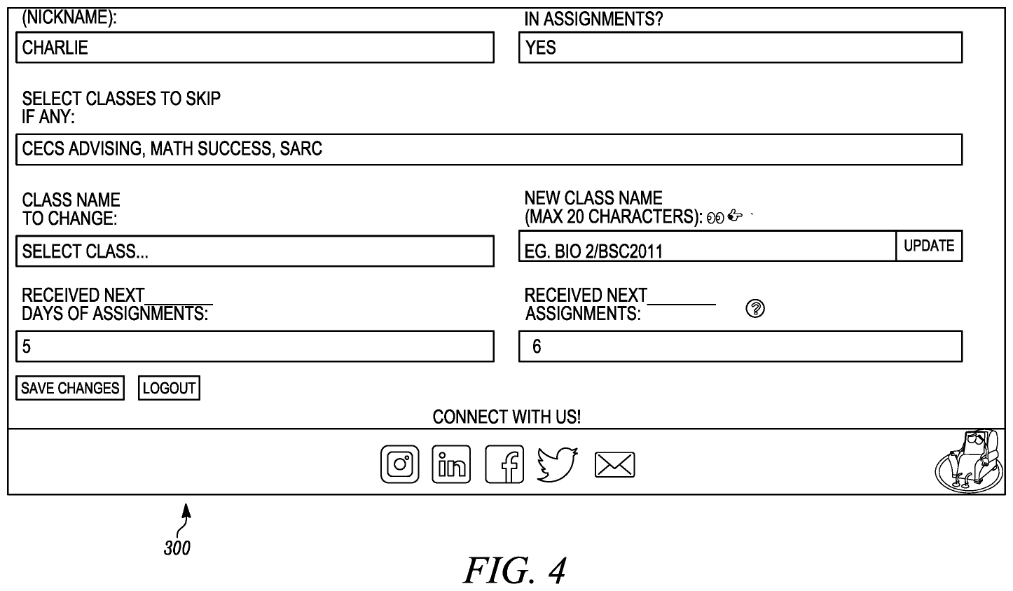

FIG. 3 and FIG. 4 are screenshots of example webpages where a user can add and/or edit their settings, according to the present invention, including, but not limited to, name to be used for text messages; whether class name is included in assignments; whether a given class is to be included in the text messages of assignments; other details for a class to be included in the text messages of assignments; number of days of assignments to be included in the text messages; and number of assignments to be included in the text messages.

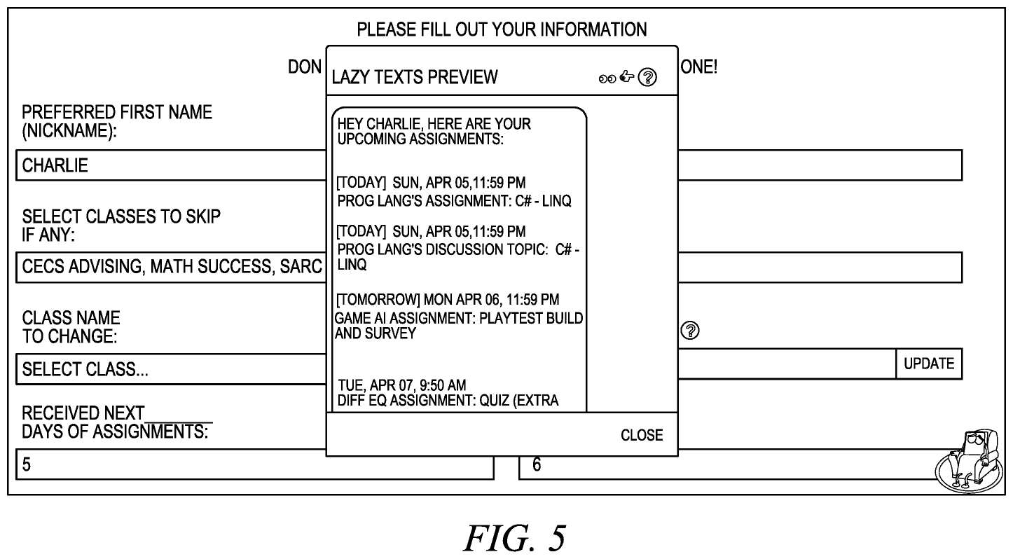

FIG. 5 are a screenshot of an example webpage that a user can preview the text message that would be received based on the settings, according to the present invention. The user can accept or change the settings based on the preview.

### Details

### Frontend

### Flow

The user signs up with their phone number on the Lazy Texts app or website.
The user verifies their phone number with a 6 digit one-time password texted to their phone.
Once verified, the user links Canvas by selecting their school and all of their third-party reminder services.
To verify and link the student's Canvas account, they are taken to the Canvas website to log in and then automatically signed up and taken back to the LazyTexts app or website.
Users can then either choose to set customizations and extra reminders, or not do anything and accept LazyTexts default settings.
Users can see a text preview that shows what their personalized text would look like.
Reminders are organized by due date/time.

### Change Course Name

User can customize course names, changes will be reflected in Canvas through Canvas API

### Customizations

Time (e.g., text sent at 5 AM)
App implicitly converts the user's set time to EST time based on the time and timezone they set, and stores that EST time in the database.
Name (e.g., Hey JOHN DOE, here are your upcoming Lazy Texts reminders:)
Show Courses (e.g., Biology Assignment: XYZ vs Assignment: XYZ)
Customize course name (e.g., Change BSC1101 to Bio)
Students can skip Courses (e.g., ALL reminders from BSC1000 will be excluded.)
Set Days (e.g., Choose to only see reminders that are 5 days out)
Limit Reminder amount (e.g., Choose to only see next 5 reminders)
Skip completed to-dos (IF reminder marked complete on the third-party reminder service, it will be excluded from text)
Birthday (e.g., Happy birthday John Doe! if the birthday is the same day as the text sent)

### Extra Reminders

Users can add their own reminders (Name, type, course, date)
They can link a reminder to a course they are enrolled in
Users can add reminders that aren't for a specific class (Academic advisor appointments, registration dates, etc.)
Users can share extra reminders with friends
Users can choose to be a part of an extra reminders group for a certain class to receive extra reminders other classmates have added.
Users can duplicate reminders with customized dates

### Profile

User can manage their linked school/other third-party reminder services
User can pause their text messages (Also done by texting STOP to the Lazy Texts phone number)

### Backend

### Reminder Sources

Canvas
Extra reminders
School messages
   Lazy Texts messages
   Email (scrape for reminders)
   Calendars (outlook, google)
   Doctor's appointments etc.

### Text Message Format

### May be Included in any Text

Advertisements via text message
Messages from LazyTexts
Messages from the user's school
Happy Birthday! (if applicable)
Good luck with your exam today! (if applicable)Normal text
   Hey (NAME), here are your upcoming Lazy Texts reminders:
   [Today/Tomorrow (if applicable)] Sat, April 10, 11:59 PM (ddd, MMM DD, h:mm A) LZY1000(COURSE ID) Assignment (Reminder type): Do the thing! (Reminder name)
   If no reminders within the next 5 (based on the user's limit reminders customization) text says: Hey NAME, you have nothing in the next x days,
   If you want to get ahead, here is your next Lazy Texts reminder:
   [Today/Tomorrow (if applicable)] Sat, April 10, 11:59 PM (ddd, MMM DD, h:mm A) LZY1000(COURSE ID) Assignment (Reminder type): Do the thing! (Reminder name)
   No reminders in a month
   Hey JOHN DOE, looks like you have nothing coming up for the next 28 days. I'll let you know when something new is assigned!

### Flow

The program is run every hour in EST (America/New_York TZ)
Queries the list of ACTIVE Lazy Texts users from the database whose selected time translated to EST is the same as when the program is run.
\hat{ } includes user's customizations and information
FOR EACH USER
   Refreshes user's access tokens to Canvas/other services.
   Validates user's data to ensure they are within defined constraints (e.g., no more than 8 reminders in the text at a time)
   Fetch user's reminder data from all sources
   Merge reminders from all sources into one list.
   Sort the list by date in ascending order.
   Cut list off based on limit days and limit reminders.
   Format list of reminders into a text message
   Send a text message to the user
   Tracks text segments sent to each user by counting characters in the text message

### Canvas Filters

Skip planner items that are marked as submitted or graded in Canvas.
Skip planner items marked as “marked complete” if the user chose to skip completed to-dos
Skip planner items marked with plannable_type of ‘wiki_page’ and ‘calendar_event’
Skip planner items marked with course_id matching to any course skipped by the user

### Operating Environment

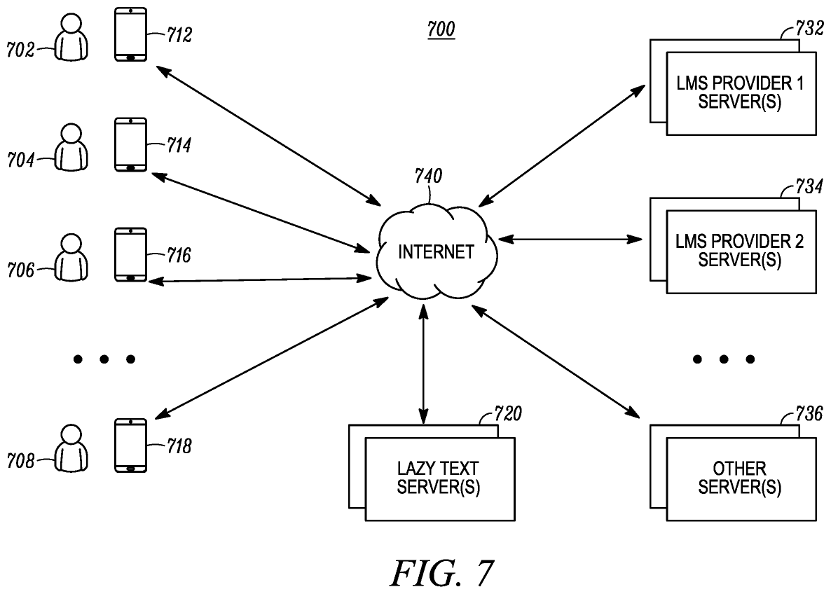

Referring to FIG. 7, is a diagram depicting the operating environment 700, according to the present invention. Are third-party server computers 732, 734, 736 connected to network, e.g., the Internet 740 or a global communication network. Also show is a Lazy Text Server 720, which is independent and managed by a separate business entity of server computers 732, 734, 736. The Lazy Text Server 720. The instruction sets and subroutines and process flows described above to manage messages between client devices 712, 714, 716, and 718 may come through the Lazy Text Server 720 or via a separate network. Examples of server computer 720, 732, 734, 736 may include, but are not limited to: a personal computer, a server computer, a series of server computers, a mini computer, and a mainframe computer.

The messages received at client devices 712, 714, 716, and 718 as a client-side application may, e.g., be a standalone application, interface with an email client application, or may be an applet/application that is executed within email client application or messaging application. Accordingly, message propagation process may be a server-based process, a client-side process and/or may be a hybrid client-side/server-based process, which may be executed, in whole or in part, by client application and by email server application. Examples of client devices 712, 714, 716, and 718 may include, but are not limited to, personal computer, laptop computer, cellular telephone, smartphone, notebook or table computer, and a dedicated network device.

Users 702, 704, 706, and 708 interact through a physical keys and keyboard, virtual keys and keyboards and other graphical user interface components such as displays, microphones, and speakers to interact with client devices 712, 714, 716, and 718.

The various client devices may be directly or indirectly coupled to network 740. For example, a client device may be directly coupled to network 740 via a hardwired network connection. Further, another client device may be wirelessly coupled to network 740 via wireless communication channel established between the client device and wireless access point (i.e., WAP IEEE 802.11a, 802.11b, 802.11g, Wi-Fi, and/or Bluetooth device), which may be directly coupled to network 740.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client devices 712, 714, 716, and 718 may each execute an operating system, examples of which may include but are not limited to Microsoft Windows, Apple iOS, Google Android, Linux, BlackBerry OS or a custom operating system.

### Information Processing System

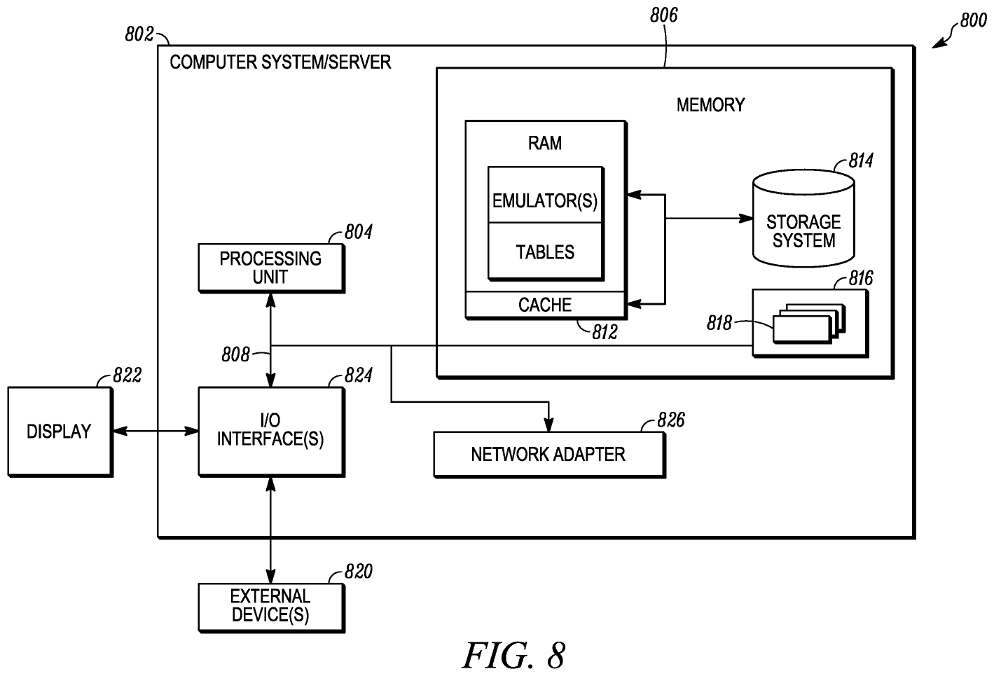

Referring now to FIG. 8, this figure is a block diagram illustrating an information processing system that can be utilized in embodiments of the present invention. The information processing system 802 is based upon a suitably configured processing system configured to implement one or more embodiments of the presently claimed invention. Any suitably configured processing system can be used as the information processing system 802 in embodiments of the present invention. The components of the information processing system 802 can include, but are not limited to, one or more processors or processing units 804, a system memory 806, and a bus 808 that couples various system components including the system memory 806 to the processor 804.

The bus 808 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

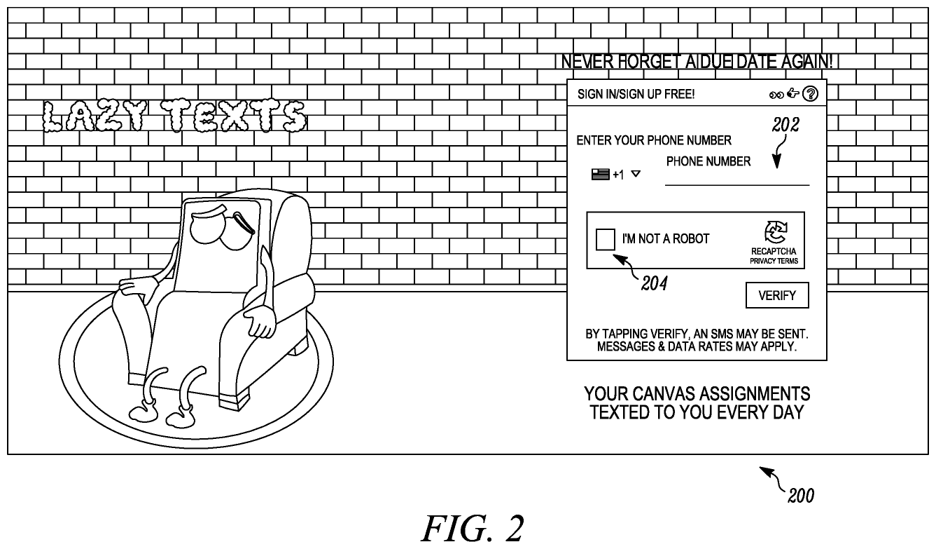

Although not shown in FIG. 8, the main memory 806 includes the emulator 844 and priority table/prioritization factor 846. The system memory 806 can also include computer system readable media in the form of volatile memory, such as random access memory (RAM) 810 and/or cache memory 812. RAM 810 includes emulator(s) 110 and sorting factor 200, such as those shown in FIG. 2.

The information processing system 802 can further include other removable/non-removable, volatile/non-volatile computer system storage media. By way of example only, a storage system 814 can be provided for reading from and writing to a non-removable or removable, non-volatile media such as one or more solid state disks and/or magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 808 by one or more data media interfaces. The memory 806 can include at least one program product having a set of program modules that are configured to carry out the functions of an embodiment of the present invention.

Program/utility 816, having a set of program modules 818, may be stored in memory 806 by way of example, and not limitation, as well as an operating system, one or more application programs, other program modules, and program data. Each of the operating system, one or more application programs, other program modules, and program data or some combination thereof, may include an implementation of a networking environment. Program modules 818 generally carry out the functions and/or methodologies of embodiments of the present invention.

The information processing system 802 can also communicate with one or more external devices 820 such as a keyboard, a pointing device, a display 822, etc.; one or more devices that enable a user to interact with the information processing system 802; and/or any devices (e.g., network card, modem, etc.) that enable computer system/server 802 to communicate with one or more other computing devices. Such communication can occur via I/O interfaces 824. Still yet, the information processing system 802 can communicate with one or more networks such as a local area network (LAN), a general wide area network (WAN), and/or a public network (e.g., the Internet) via network adapter 826. As depicted, the network adapter 826 communicates with the other components of information processing system 802 via the bus 808. Other hardware and/or software components can also be used in conjunction with the information processing system 802. Examples include, but are not limited to: microcode, device drivers, redundant processing units, external disk drive arrays, RAID systems, tape drives, and data archival storage systems.

### Non-Limiting Examples

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been discussed above with reference to flowchart illustrations and/or block diagrams of methods, apparatus (systems) and computer program products according to various embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The description of the present application has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

FIG. 8 is a block diagram illustrating one example of a client or server information processing system; and

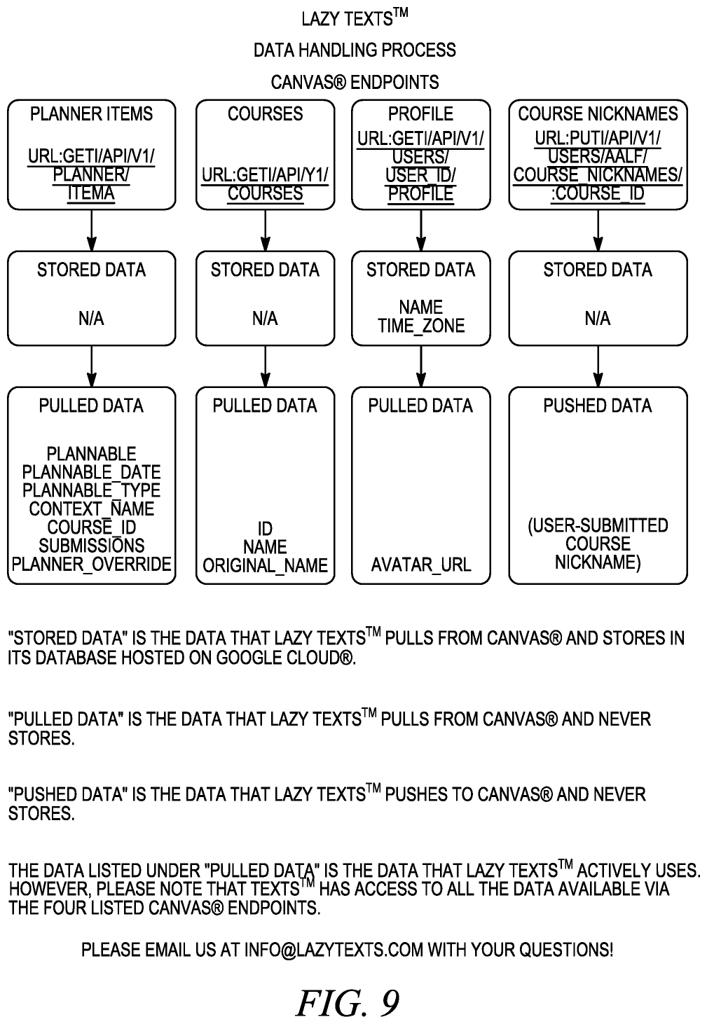

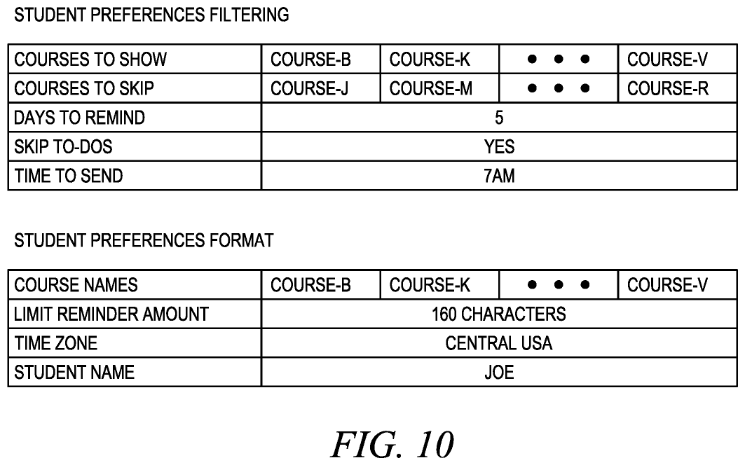

FIG. 9 is a table of values stored locally at a client device when prioritizing what data is to be sent to the cloud to enable continue access by other client devices.

### Non-Limiting Examples

All references cited herein are expressly incorporated by reference in their entirety. It will be appreciated by persons skilled in the art that the present disclosure is not limited to what has been particularly shown and described herein above. In addition, unless mention was made above to the contrary, it should be noted that all of the accompanying drawings are not to scale. There are many different features to the present disclosure and it is contemplated that these features may be used together or separately. Thus, the disclosure should not be limited to any particular combination of features or to a particular application of the disclosure. Further, it should be understood that variations and modifications within the spirit and scope of the disclosure might occur to those skilled in the art to which the disclosure pertains. Accordingly, all expedient modifications readily attainable by one versed in the art from the disclosure set forth herein that are within the scope and spirit of the present disclosure are to be included as further embodiments of the present disclosure.

What is claimed is:

1. A method for providing student-control short message service (SMS) comprising:
accessing, by a server, data in a third-party format from a third-party server, where the server and the third-party server are controlled by different business entities;
filtering the data in the third-party format which has been accessed according to student preferences, the student preferences including a mobile device identifier;
converting the data in the third-party format which as specified by the student preferences into a format compatible with the SMS protocol or an instant message for receipt by a messaging app; and
sending the data which has been converted into the SMS format or instant message to the mobile device as specified by the mobile device identifier.

2. The method of claim 1, wherein the accessing is performed using one or more of API calls, web scrapping, file transfer protocol (FTP), and http methods.

3. The method of claim 1, further comprising:
sending the data which has been converted into the SMS format to an SMS gateway to send to the mobile device as specified by the mobile device identifier.

4. The method of claim 1, wherein the student preferences for filtering includes one or more of show courses, skip courses, set days, and skip completed to-dos.

5. The method of claim 1, wherein the student preferences for formatting includes one or more of customized course names, time format, time-zone, name, and limit reminder amount.

6. The method of claim 1, wherein the data in the third-party format from the third-party server includes a learning management system, email system and other data sources.

7. The method of claim 1, further comprising:
accessing, by the server, data in an additional third-party format from an additional third-party server, where the server and the additional third-party server are controlled by different business entities;
filtering the data in the additional third-party format which has been accessed according to student preferences, the student preferences including a mobile device identifier;
converting the data in the additional third-party format which as specified by the student preferences into a format compatible with the SMS protocol or an instant message for receipt by a messaging app; and
sending the data which has been converted into the SMS format or instant message to the mobile device as specified by the mobile device identifier.

8. A conversation device to provide student-control short message service (SMS), comprising:
a processor device; and
a memory operably coupled to the processor device and storing computer-executable instructions causing:
accessing, by a server, data in a third-party format from a third-party server, where the server and the third-party server are controlled by different business entities;
filtering the data in the third-party format which has been accessed according to student preferences, the student preferences including a mobile device identifier;
converting the data in the third-party format which as specified by the student preferences into a format compatible with the SMS protocol or an instant message for receipt by a messaging app; and
sending the data which has been converted into the SMS format or instant message to the mobile device as specified by the mobile device identifier.

9. A computer program product for using a computing device to provide student-control short message service (SMS), comprising:
a non-transitory computer readable storage medium readable by a processing device and storing program instructions for execution by the processing device, said program instructions comprising:
accessing, by a server, data in a third-party format from a third-party server, where the server and the third-party server are controlled by different business entities;
filtering the data in the third-party format which has been accessed according to student preferences, the student preferences including a mobile device identifier;
converting the data in the third-party format which as specified by the student preferences into a format compatible with the SMS protocol or an instant message for receipt by a messaging app; and
sending the data which has been converted into the SMS format or instant message to the mobile device as specified by the mobile device identifier.
